(19) United States
(12) Patent Application Publication
(10) Pub. No.: US 2023/0161007 A1
(43) Pub. Date: May 25, 2023

(54) LIDAR APPARATUS

(71) Applicant: HL KLEMOVE CORP., Incheon (KR)

(72) Inventors: HoSeok SHIN, Gyeonggi-do (KR); Chul Seung LEE, Gyeonggi-do (KR); Seong Hee JEONG, Gyeonggi-do (KR); Yun Ki HAN, Gyeonggi-do (KR); Hak Gu HAN, Gyeonggi-do (KR)

(21) Appl. No.: 17/919,265

(22) PCT Filed: Apr. 16, 2021
(86) PCT No.: PCT/KR2021/004820

§ 371 Date: Oct. 15, 2022

(30) Foreign Application Priority Data
Apr. 16, 2020 (KR) 10-2020-0046053

(51) Int. Cl. G01S 7/481; G01S 7/52; H05B 3/84

(52) U.S. Cl. CPC G01S 7/4813; G01S 7/52006; H05B 3/84; G01S 7/4812; H05B 2203/013

(57) ABSTRACT

A LIDAR apparatus is disclosed. A LIDAR apparatus according to an embodiment of the present invention comprises a cover window which covers a transmission path and reception path of laser light and is disposed in the same, and comprises a heating unit which covers a surface of the cover window and is disposed at the same, and a heating control unit connected to the heating unit to control the same.

### CROSS-REFERENCE TO RELATED APPLICATION

This application claims priority to and the benefit of Korean Patent Application No. 10-2020-0046053, filed on Apr. 16, 2020, the disclosure of which is incorporated herein by reference in its entirety.

### TECHNICAL FIELD

The present invention relates to a LIDAR apparatus, and more specifically to a LIDAR apparatus that measures an object or atmospheric phenomenon by using pulsed laser light that is emitted and then reflected and returned.

### BACKGROUND ART

The LIDAR (Light Detection And Ranging) apparatus is a radar device that uses a laser to detect surrounding objects and atmospheric phenomena. The LIDAR apparatus emits a laser pulse, receives the reflected light from the surrounding target object, and measures the distance to the object, atmospheric phenomenon and the like.

Through the LIDAR apparatus, it is possible to precisely detect surrounding objects and terrain features and model the same as 3D images. Due to these characteristics, the LIDAR apparatus is attracting attention as a core sensor in the autonomous driving technology of vehicles.

The LIDAR apparatus includes an optical system including a light transmitting unit and a light receiving unit. Since such an optical system must to be protected from the external environment, it is generally disposed in a housing, and laser light transmitted from the light transmitting unit and laser light received from the light receiving unit pass through a cover window which is coupled to the housing.

If moisture or window frost is generated on the cover window due to factors such as the usage temperature and humidity of the LIDAR apparatus, it becomes a factor in the transmission and reception of laser light. Accordingly, it is unavoidable that the performance of the LIDAR apparatus may be deteriorated.

Meanwhile, securing air tightness is required for the protection and performance maintenance of the optical syste and damage may occur in the cover window of the LIDAR apparatus depending on the usage environment (e.g., due to the impact applied while driving a vehicle when used in combination with the vehicle). In this case, there is a risk of damage to the optical system if no immediate action is taken against the damage.

(Patent Document) Korean Patent Application No. 10-2015-0061330 “LIDAR SENSOR SYSTEM”, published on Jun. 4, 2015

### DISCLOSURE

### Technical Problem

The present invention has been devised to solve the problems of prior art described above, and an object of the present invention to provide a LIDAR apparatus which is capable of preventing moisture or frost from forming on a cover window disposed on a transmission path and a reception path of laser light.

Another object of the present invention is to provide a LIDAR apparatus which is capable of taking immediate action for protection of an optical system by enabling the accurate detection of damage to a cover window coupled to a housing for the protection of the optical system.

### Technical Solution

According to an aspect of the present invention, provided is a LIDAR apparatus which includes a cover window which covers a transmission path and reception path of laser light and is disposed in the same, and the LIDAR apparatus includes a heating unit which covers a surface of the cover window and is disposed at the same; and a heating control unit connected to the heating unit to control the heating unit.

In this case, the heating unit may be formed of a heating film.

In addition, the heating film may be formed to be transparent.

In addition, the heating film may be disposed to have an area corresponding to the area of one surface of the cover window.

In addition, the LIDAR apparatus may further include a temperature measuring unit which is coupled to the cover window or disposed adjacent to the cover window to measure the temperature and transmit the same to the heating control unit.

In addition, the LIDAR apparatus may further include a resistor unit which is disposed to cover the other surface of the cover window; and a detection unit for detecting whether the cover window is damaged by detecting a change in resistance of the resistor unit.

In addition, the resistor unit may have a matrix structure.

In addition, the resistor unit may be formed of a transparent resistance film.

In addition, the cover window may be coupled to a housing that protects an optical system for transmitting and receiving the laser light from an external environment, and wherein the heating unit may be disposed on a surface located inside the housing among both surfaces of the cover window, and the resistor unit is disposed on a surface located outside the housing among both surfaces of the cover window.

According to another aspect of the present invention, provided is a LIDAR apparatus, including a cover window which covers a transmission path and reception path of laser light and is disposed in the same, and further including a resistor unit which is disposed to cover a surface of the cover window; and a detection unit for detecting whether the cover window is damaged by detecting a change in resistance of the resistor unit.

In this case, the resistor unit may have a matrix structure.

In addition, the resistor unit may be formed of a transparent resistance film.

### Advantageous Effects

According to an exemplary embodiment of the present invention, it is possible to effectively prevent moisture or frost from forming on a cover window through a heating unit disposed to cover the cover window of the LIDAR apparatus.

In addition, according to an exemplary embodiment of the present invention, it is possible to accurately and quickly detect whether the cover window is damaged by detecting a change in resistance of the resistor unit which is disposed to cover the cover window of the LIDAR apparatus.

### DESCRIPTION OF DRAWINGS

FIG. 1 is a schematic configuration diagram of the LIDAR apparatus according to an exemplary embodiment of the present invention.

FIG. 2 is a diagram showing a heating unit and a heating control unit of the LIDAR apparatus according to an exemplary embodiment of the present invention.

FIG. 3 is a diagram showing a resistor unit and a detection unit of the LIDAR apparatus according to an exemplary embodiment of the present invention.

FIG. 4 is a diagram showing an example of detecting damage to a cover window through a resistor unit and a detection unit of the LIDAR apparatus according to an exemplary embodiment of the present invention.

FIG. 5 is a detailed configuration diagram of the LIDAR apparatus according to an exemplary embodiment of the present invention.

FIG. 6 is a diagram showing an example of an optical system of the LIDAR apparatus according to an exemplary embodiment of the present invention.

FIG. 7 is a diagram showing the operation of the LIDAR apparatus according to an exemplary embodiment of the present invention.

FIG. 8 is a view showing the operation of a heating unit in the LIDAR apparatus according to an exemplary embodiment of the present invention.

FIG. 9 is a diagram showing a process in which the detection of damage to a cover window and the action are performed based on a change in resistance of a resistor unit in the LIDAR apparatus according to an exemplary embodiment of the present invention.

### MODES OF THE INVENTION

Hereinafter, with reference to the accompanying drawings, the exemplary embodiments of the present invention will be described in detail so that those of ordinary skill in the art can easily practice the present invention. The present invention may be embodied in many different forms and is not limited to the exemplary embodiments described herein. In order to clearly describe the present invention, parts that are irrelevant to the description are omitted from the drawings, and the same reference numerals are assigned to the same or similar components throughout the specification.

In the present specification, terms such as “include” or “have” are intended to designate that a feature, number, step, operation, component, part or combination thereof described in the specification exists, but it should be understood that it does not preclude the possibility of addition or existence of one or more other features or numbers, steps, operations, components, parts or combinations thereof.

In the present specification, spatially relative terms such as “front”, “rear”, “above” or “below” may be used to describe a correlation with the components illustrated in the drawings. These are relative terms determined based on what is illustrated in the drawings, and the positional relationship may be conversely interpreted according to the orientation.

The presence of a component in “front”, “behind”, “above” or “below” of another component includes not only that, unless otherwise specified, it is in direct contact with another component and disposed in “front”, “behind”, “above” or “below”, but also cases in which another component is disposed in the middle. In addition, when a component is “connected” with another component, it includes not only direct connection to each other but also indirect connection to each other, unless otherwise specified.

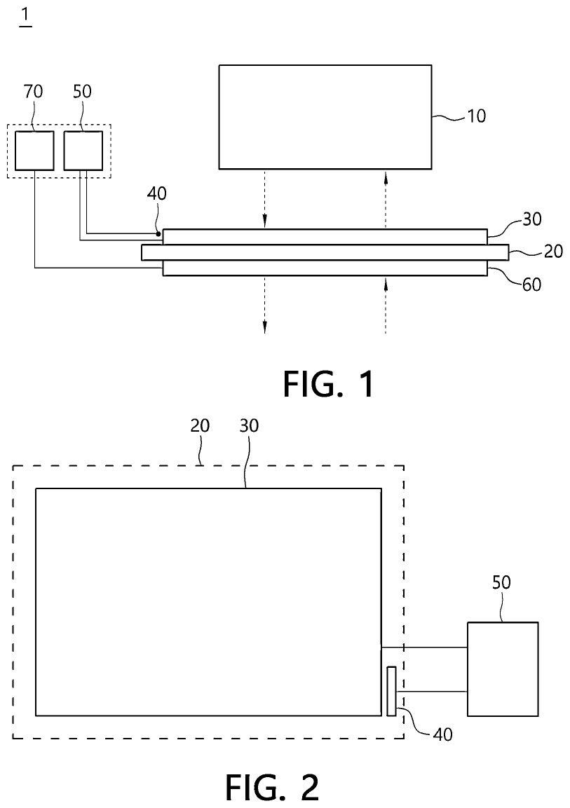

FIG. 1 is a schematic configuration diagram of the LIDAR apparatus according to an exemplary embodiment of the present invention.

The LIDAR apparatus 1 according to an exemplary embodiment of the present invention is a device that transmits laser light and receives laser light reflected back from an external object to measure the distance to the external object. The LIDAR apparatus 1 according to an exemplary embodiment of the present invention may be installed in a vehicle and used as a means for collecting information which is necessary for driver assistance or autonomous driving.

Referring to FIG. 1, the LIDAR apparatus 1 according to an exemplary embodiment of the present invention includes an optical system 10, a cover window 20, a heating unit 30, a temperature measuring unit 40, a heating control unit 50, a resistor unit 60 and a detection unit 70.

The optical system 10 generates and transmits laser light to the outside, and receives and detects laser light reflected back by an external object. The optical system 10 may include a light transmitting unit for transmitting laser light, and a light receiving unit for receiving laser light that is reflected from the outside after being transmitted from the light transmitting unit and returns.

The cover window 20 is disposed to cover a transmission path and a reception path of the laser light. For example, the cover window 20 may be disposed to cover one side of the housing for protecting the optical system including the light transmitting unit and the light receiving unit from the external environment.

Referring to FIG. 2, the heating unit 30 is disposed to cover one surface of the cover window 20. When the cover window 20 is coupled to the housing for protecting the optical system 10, the heat generating unit 30 may be disposed on a surface located inside the housing among both surfaces of the cover window 20.

The heat generating unit 30 heats the cover window 20. The heat provided by the heat generating unit 30 removes moisture, frost or the like, which is generated in the cover window 20, or prevents the generation of moisture, frost or the like in advance.

The heating unit 30 may include any one or more of a heating element and a heating material. In addition, the heat generation of the heat generating unit 30 may be controlled by the heating control unit 50.

In more detail, the heating unit 30 may be formed of a heating film. In this case, the heating film may be transparently formed for the smooth transmission of laser light. That is, the heating unit 30 may be formed of a transparent heating film which is attached to one surface of the cover window 20.

In addition, when the heating unit 30 is formed of a heating film, the heating film may be disposed to have an area corresponding to the area of one surface of the cover window 20. In other words, the heating unit 30 may be disposed to cover one surface of the cover window 20 at a scale of 1:1.

When the heating unit 30 is formed of a transparent heating film disposed to cover one surface of the cover window 20 at a scale of 1:1, the efficiency of transmitted laser light is increased. In addition, it is possible to uniformly generate the internally scattered light to form a uniform noise level.

The temperature measuring unit 40 is coupled to the cover window 20 or disposed adjacent to the cover window 20 to measure the temperature. The temperature measuring unit 40 may be disposed inside the housing to measure the temperature inside the housing. The temperature measurement unit 40 transmits the measured temperature to the heating control unit 50. For example, the temperature measuring element of the temperature measuring unit 40 may be formed of a thermistor.

In an exemplary embodiment of the present invention, the temperature measured by the temperature measurement unit 40 is transmitted to the heating control unit 50. The temperature measured by the temperature measuring unit 40 may be used as reference information when the heating control unit 50 controls the heating unit 30.

The heating control unit 50 is connected to the heating unit 30 to control the heating unit 30. The heating control unit 50 may control the heat generating unit 30 to generate heat or to stop the heat generation. Specifically, the heating control unit 50 may compare a preset reference value with the temperature measured by the temperature measurement unit 40 and control the heating unit 30 to generate heat when it is determined that heating is necessary.

The heating control unit 50 may be formed of an electronic control unit. Specifically, the heating control unit 50 may be formed of a control circuit implemented on one substrate.

In addition, the heating control unit 50 may be disposed on one substrate, for example, a flexible printed circuit board (FPCB) together with a detection unit 70. This simplifies circuit wiring and ensures space efficiency.

The heating control unit 50 may be disposed outside the housing rather than inside the housing. For example, when the LIDAR apparatus 1 is installed in a vehicle, the heating control unit 50 may be disposed together with a main electronic control unit of the vehicle. Certainly, it may be considered that the heating control unit 50 is disposed inside the housing depending on the circumstances.

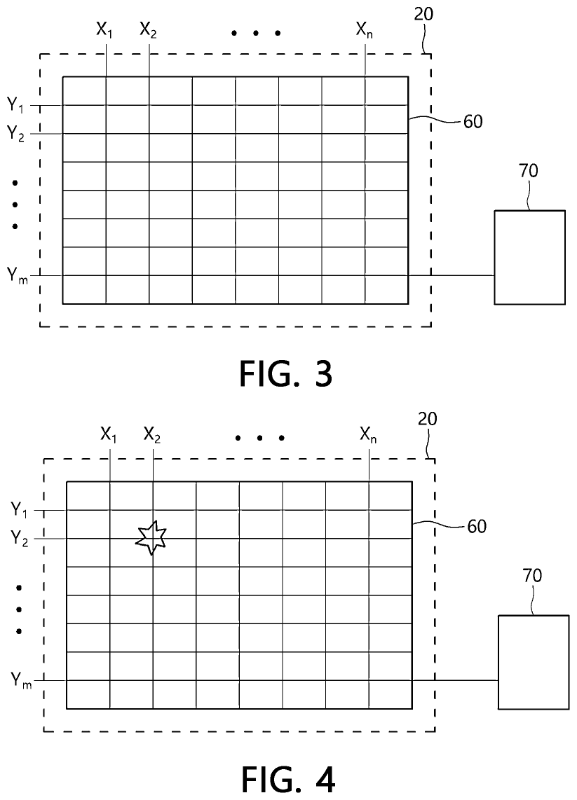

Referring to FIG. 3, the resistor unit 60 is disposed to cover the other surface of the cover window 20. When the cover window 20 is coupled to the housing for protecting the optical system 10, the resistor unit 60 may be disposed on a surface located outside the housing among both surfaces of the cover window 20.

The resistor unit 60 is formed of a resistance element. When the resistor unit 60 is deformed or damaged due to damage to the cover window 20, the resistance value of the resistor unit 60 is changed, and through this, damage to the cover window 20 may be detected. The resistor unit 60 may be formed of a transparent resistive film so as not to obstruct the path of the laser light.

The resistor unit 60 may have a matrix structure. More specifically, the resistor unit 60 may be disposed to partition the cover window 20 into a plurality of grids. When the resistance value of the resistor unit 60 is changed due to damage to the cover window 20 due to the resistor unit 60 being configured in this way, it is possible to determine not only whether the resistor unit 60 is changed, but also at which part of the resistor unit 60 a change in the resistance value has occurred, and accordingly, it is possible to accurately detect a damaged part of the cover window 20.

The detection unit 70 detects a change in resistance of the resistor unit 60 to detect whether the cover window 20 is damaged. The detection unit 70 checks the degree of impact and uniformity of the cover window 20 to determine whether to continuously drive the system. More specifically, the detection unit 70 monitors whether the resistance value is changed through a current flowing through the resistance element of the resistor unit 60, and by detecting whether the resistance value has changed and at which part the change in the resistance value has occurred, it is possible to detect whether the cover window 20 is damaged and the damaged part.

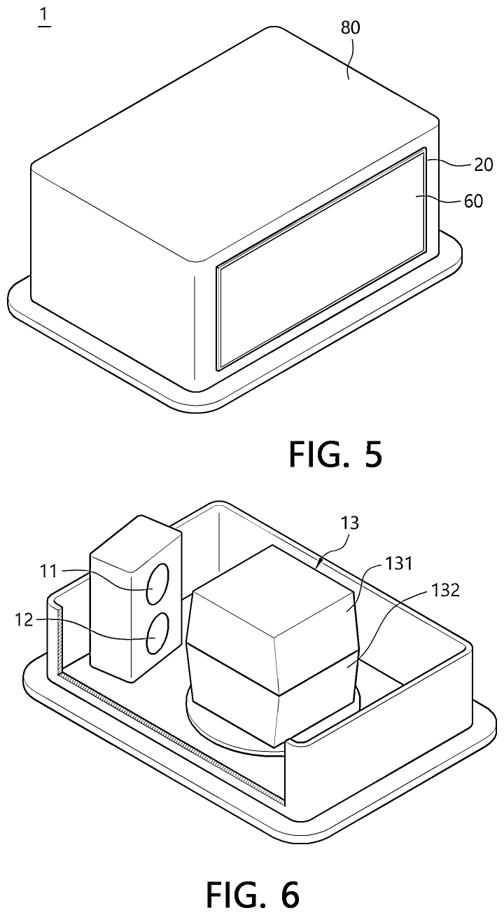

Referring to FIG. 4, when the resistor unit 60 partitions a cover surface of the cover window 20 into an n×m matrix, if a change in the resistance value has occurred at a coordinate (X2, Y2) of the resistor unit 60, the detection unit 70 detects this and detects that the area of the cover window 20 corresponding to the coordinate (X2, Y2) of the resistor unit 60 has been damaged.

The detection unit 70 may be formed of an electronic control unit. Specifically, the detection unit 70 may be formed of a control circuit implemented on one substrate. As described above, the detection unit 70 may be disposed on one substrate, for example, a flexible printed circuit board (FPCB) together with the heating control unit 50.

Similar to the heating control unit 50, the detection unit 70 may be disposed outside the housing rather than inside the housing. For example, when the LIDAR apparatus 1 is installed in a vehicle, the detection unit 70 may be disposed together with a main electronic control unit of the vehicle. Certainly, it may be considered that the detection unit 70 is disposed inside the housing depending on the circumstances.

FIG. 5 is a detailed configuration diagram of the LIDAR apparatus according to an exemplary embodiment of the present invention. FIG. 6 is a diagram showing an example of an optical system of the LIDAR apparatus according to an exemplary embodiment of the present invention.

Referring to FIGS. 5 and 6, in an exemplary embodiment of the present invention, the housing 80 may be formed in a box shape. In addition, the cover window 20 is disposed to cover one surface of the housing 80. In addition, the optical system 10 is disposed inside the housing 80.

In this case, the laser light transmitted from the optical system 10 or the laser light received by the optical system 10 passes through the cover window 20 covering one side of the housing 80.

More specifically, the optical system 10 includes a light transmitting unit 11, a light receiving unit 12 and a scanner 13. The light transmitting unit 11 and the light receiving unit 12 are fixed in the housing 80, and the scanner 13 is rotatably disposed about a rotation axis passing through the center in a vertical direction. That is, the laser light transmitted through the light transmitting unit 11 is reflected by the scanner 13 and transmitted to the outside, and the laser light reflected back by the external object is reflected by the scanner 13 and transmitted to the light receiving unit 12.

The light transmitting unit 11 and the light receiving unit 12 are arranged to be stacked. The light transmitting unit 11 is disposed above the light receiving unit 12, and the light receiving unit 12 is disposed below the light transmitting unit 11. The light transmitting unit 11 and the light receiving unit 12 are vertically aligned and arranged.

The scanner 13 rotates with a plurality of reflective surfaces, and reflects the laser light transmitted from the light transmitting unit 11 to the outside or reflects the laser light received by being reflected from the outside and transmits the same to the light receiving unit 12. An actuator (e.g., a motor) for rotation of the scanner 13 may be provided inside or below the scanner 13.

The scanner 13 has a structure in which polygon mirrors are stacked in multiple layers. Specifically, in the present exemplary embodiment, the scanner 13 includes a first polygon mirror 131 and a second polygon mirror 132. The first and second polygonal mirrors 131, 132 respectively have a quadrangular shape and have four reflective surfaces.

The inclination angles with respect to the vertical direction of the reflective surfaces included in each polygonal mirror may be formed differently. For example, the inclination angles of the reflective surfaces included in each polygonal mirror with respect to the vertical direction may be configured to gradually decrease or increase in the rotation direction. With this configuration, each polygonal mirror may provide a plurality of vertical channels.

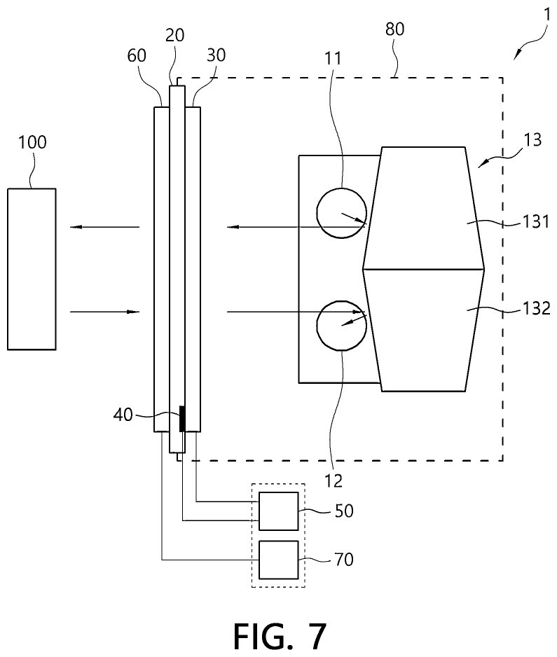

Referring to FIG. 7, the first polygonal mirror 131 is disposed adjacent to the light transmitting unit 11 to reflect the laser light transmitted from the light transmitting unit 11. In addition, the second polygonal mirror 132 is disposed on the light receiving unit 12 to reflect the received laser light, and transmits the same to the light receiving unit 12.

Certainly, the detailed configurations of the optical system 10, that is, the light transmitting unit 11, the light receiving unit 12 and the scanner 13 are merely one example. The optical system including the light transmitting unit 11, the light receiving unit 12, the scanner 13 and the like may be changed according to the required performance or usage environment of the LIDAR apparatus.

For example, the scanner 13 may be composed of three or more multi-layers, and the number of reflective surfaces of the polygonal mirror disposed on each layer, the angle of each reflective surface with respect to the vertical direction and the like may be modified according to the required performance of the LIDAR apparatus. In addition, the number and arrangement of the light transmitting unit 11 and the light receiving unit 12 may vary depending on the shape of the scanner 13. Furthermore, the scanner 13 may be omitted according to the operation method of the LIDAR apparatus.

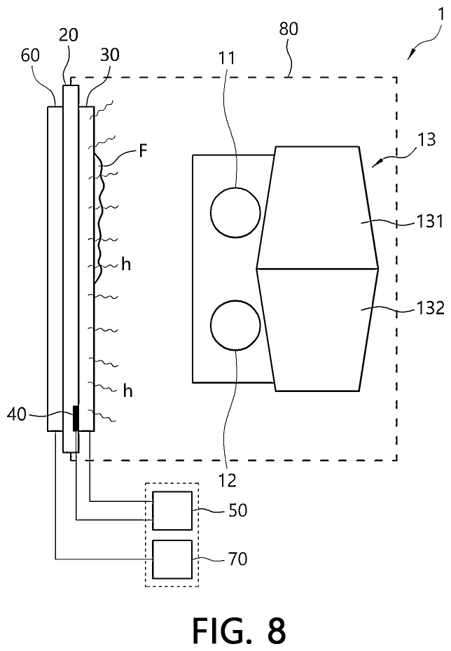

FIG. 8 shows the operation of a heating unit in the LIDAR apparatus according to an exemplary embodiment of the present invention.

Referring to FIG. 8, when it is determined that frost (F) has occurred on the cover window 20 based on information such as the temperature measured by the temperature measuring unit 40, the heating control unit 50 controls the heating unit 30 to generate heat (h). Accordingly, the frost (F) generated on the cover window 20 by the heat (h) is removed, and the performance degradation of the LIDAR apparatus 1 may be prevented.

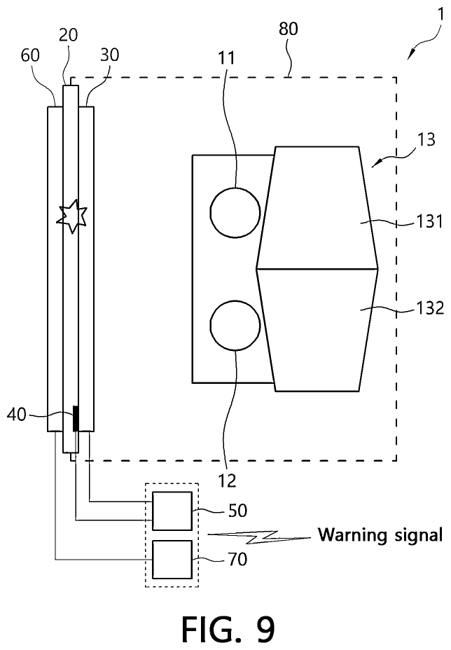

FIG. 9 shows a process in which the detection of damage to a cover window and the action are performed based on a change in resistance of a resistor unit in the LIDAR apparatus according to an exemplary embodiment of the present invention.

When damage occurs to the cover window 20 in the process of using the LIDAR apparatus 1, the resistance element of the resistor unit 60 is deformed or damaged to cause a change in the resistance value, and the detection unit 70 may detect whether the cover window 20 is damaged and the damaged part thereof based on the change in the resistance value. The detection unit 70 may generate a warning signal when an immediate stoppage of operation or repair is required for system protection. For example, when the LIDAR apparatus 1 according to an exemplary embodiment of the present invention is installed in a vehicle, the detection unit 70 may output a warning signal or generate a warning sound on the instrument panel of the vehicle.

Although an exemplary embodiment of the present invention has been described, the spirit of the present invention is not limited by the exemplary embodiments presented herein, and those skilled in the art who understand the spirit of the present invention will be able to easily suggest other exemplary embodiments by modifying, changing, deleting or adding components within the scope of the same spirit, but this is also said to be within the scope of the present invention.

1. A LIDAR apparatus which comprises a cover window which covers a transmission path and reception path of laser light and is disposed in the same, the LIDAR apparatus comprising:
a heating unit which covers a surface of the cover window and is disposed at the same; and
a heating control unit connected to the heating unit to control the heating unit.

2. The LIDAR apparatus of claim 1, wherein the heating unit is formed of a heating film.

3. The LIDAR apparatus of claim 2, wherein the heating film is formed to be transparent.

4. The LIDAR apparatus of claim 3, wherein the heating film is disposed to have an area corresponding to the area of one surface of the cover window.

5. The LIDAR apparatus of claim 1, further comprising:
a temperature measuring unit which is coupled to the cover window or disposed adjacent to the cover window to measure the temperature and transmit the same to the heating control unit.

6. The LIDAR apparatus of claim 1, further comprising:
a resistor unit which is disposed to cover the other surface of the cover window; and
a detection unit for detecting whether the cover window is damaged by detecting a change in resistance of the resistor unit.

7. The LIDAR apparatus of claim 6, wherein the resistor unit has a matrix structure.

8. The LIDAR apparatus of claim 6, wherein the resistor unit is formed of a transparent resistance film.

9. The LIDAR apparatus of claim 6, wherein the cover window is coupled to a housing that protects an optical system for transmitting and receiving the laser light from an external environment, and
wherein the heating unit is disposed on a surface located inside the housing among both surfaces of the cover window, and the resistor unit is disposed on a surface located outside the housing among both surfaces of the cover window.

10. A LIDAR apparatus, comprising:
a cover window which covers a transmission path and reception path of laser light and is disposed in the same, and further comprising:
a resistor unit which is disposed to cover a surface of the cover window; and
a detection unit for detecting whether the cover window is damaged by detecting a change in resistance of the resistor unit.

11. The LIDAR apparatus of claim 10, wherein the resistor unit has a matrix structure.

12. The LIDAR apparatus of claim 10, wherein the resistor unit is formed of a transparent resistance film.
